(19) United States
(12) Patent Application Publication
(10) Pub. No.: US 2008/0303660 A1
(43) Pub. Date: Dec. 11, 2008

(54) EMERGENCY EVENT DETECTION AND ALERT SYSTEM AND METHOD

(75) Inventor: Carl A. Lombardi, Medina, WA (US)

Correspondence Address: AXIOS LAW GROUP. PLLC, 1525 FOURTH AVENUE, SUITE 800, SEATTLE, WA, 98101, US

(73) Assignee: TELASIO, LLC, Medina, WA (US)

(21) Appl. No.: 12/137,490

(22) Filed: Jun. 11, 2008

Related U.S. Application Data
(60) Provisional application No. 60/943,257, filed on Jun. 11, 2007.

(51) Int. Cl. G08B 21/00

(52) U.S. Cl. 340/540

(57) ABSTRACT

Systems and methods are provided herein that provide for emergency event detection and alert.

### RELATED REFERENCES

This application claims priority to U.S. Provisional Application 60/943,257 filed Jun. 11, 2007. The foregoing application is hereby incorporated by reference in its entirety as if fully set forth herein.

### FIELD

This invention relates generally to alert systems, and more specifically, to systems and methods for providing emergency event detection and alert.

### BACKGROUND

Each year in the United States alone, many fire trucks, ambulances, police cars, police motorcycles, and other vehicles responding to emergencies are involved in accidents that lead to injury or death. Many of these accidents occur because drivers in nearby cars are either unaware of the emergency vehicle or unable to locate the emergency vehicle. While many emergency vehicles use sophisticated devices to signal their presence to nearby traffic signals and to other emergency vehicles, most drivers and pedestrians are alerted to the presence of an emergency vehicle by a simple audible siren. As vehicle interiors become more tightly sealed and insulated against external sound, coupled with the use of car stereos and entertainment systems, it becomes increasingly difficult for drivers to hear an approaching emergency vehicle siren in time to avoid impeding the vehicle's progress. Further compounding the problem, many sirens use a narrow-band sound signal that may be difficult for a driver to localize. In fact, studies have shown that narrow band siren signals may actually mislead drivers about where the emergency vehicle is located. Because current emergency vehicles use such an ineffective system to signal their presence to other drivers and pedestrians in the vicinity, emergency response times may be increased and public safety may be unnecessarily endangered.

Emergency vehicles in many locales transmit emergency vehicle preemption (“EVP”) signals that are designed to give emergency vehicles a right of way (green light) on their approach to an intersection that is controlled by a traffic light, while blocking (giving a red light to) conflicting approaches. EVP systems may make use of a variety of signals, including visible and infrared light, radio band signals, microwave signals, and even audible signals. Such systems have improved safety at intersections, but in between intersections, emergency vehicles still need drivers to yield the right of way to the emergency vehicle. However, drivers cannot yield if they are unaware of or cannot localize the emergency vehicle. Drivers and pedestrians need a better system for discovering the existence and location of nearby emergency vehicles as well as other vehicles.

In addition to emergency events, it is difficult for drivers and pedestrians to discover the existence of various non-emergency situations. For example, traffic congestion, construction, road closures, train crossings, weather phenomena, and the like may be important for a drivers and pedestrians to be aware of to improve their safety, but unfortunately, such events may be difficult to identify until it is too late. Moreover, is difficult for pedestrians and drivers to locate non-emergency vehicles such as trains, light rail cars, and aircraft, especially since these vehicles typically fail to provide an alert to their presence.

### BRIEF DESCRIPTION OF THE DRAWINGS

The present invention will be described by way of exemplary embodiments but not limitations, illustrated in the accompanying drawings in which like references denote similar elements, and in which:

FIG. 1 shows an emergency vehicle transmitting a signal to a nearby passenger car in accordance with one embodiment.

FIG. 2 is an illustration of a visual driver alert display in accordance with one embodiment.

FIG. 3 is an illustration of a standalone driver alert device in a vehicle in accordance with one embodiment.

FIG. 4 is an illustration of one embodiment of a multi-component driver alert device in a vehicle in accordance with one embodiment.

FIG. 5 is an illustration of a full-car integrated alert display in accordance with one embodiment.

FIG. 6 is an illustration of one possible full-car integrated system sensor location scheme in accordance with one embodiment.

FIG. 7 is a block diagram of a device that provides an exemplary operating environment for various embodiments.

FIG. 8 is a diagram illustrating the actions taken by an alert device in accordance with various embodiments.

FIG. 9 is an illustration of a standalone driver alert device in accordance with one embodiment.

FIG. 10 is a pictorial diagram of a system of interconnected devices, in accordance with one embodiment.

FIG. 11 is a pictorial diagram of a system of interconnected devices, in accordance with another embodiment.

FIG. 12 is a diagram illustrating the actions taken by a pair of alert devices in accordance with various embodiments.

FIG. 13 is a block diagram of an event indicator analysis routine in accordance with an embodiment.

### DESCRIPTION

Illustrative embodiments presented herein include, but are not limited to, systems and methods for emergency event detection and alert.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

For purposes of illustration, reference is made herein to “emergency events” and “emergency vehicles”; however, such descriptions are made for purposes of illustration only, and various embodiments relate to non-emergency events as well as emergency events. For example, non-emergency events may include presence of non-emergency vehicles, traffic conditions, weather phenomena, construction, and the like. Additionally, it should be clear to one of ordinary skill in the art that the term vehicle may be broadly applied to all types of vehicles, such as automobiles, motorcycles, bicycles, trains, aircraft, and the like.

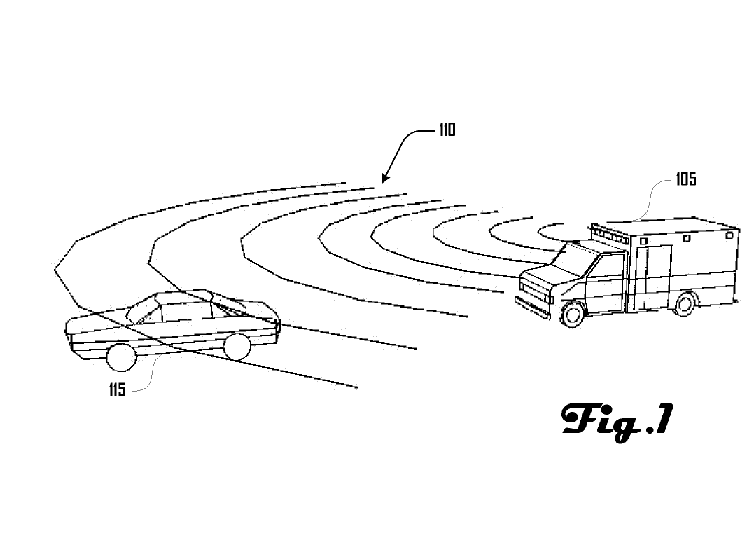

Described herein is an alert system 700, which in some embodiments comprises one or more sensor that provides data to a processing device that detects the presence of one or more signal 1 10 transmitted from an emergency vehicle 105. In some embodiments, a device may be installed temporarily or permanently in a vehicle 115 and may provide an alert to a driver and/or passengers of the vehicle 115 as to the presence and of an emergency vehicle 105 within proximity of the device. In other embodiments, a user may be presented with an alert of an emergency event and/or the location of an emergency event or emergency vehicle 105. For example, as illustrated in FIG. 1, a signal is transmitted by an emergency vehicle 105 (i.e. an ambulance), which may be detected by an alert device 700 associated with a vehicle 115

In some embodiments, a user may be presented with various types of alerts to an emergency event. In some embodiments, an alert device 700 may interface with a radio, sound system, visual display system, global positioning system, alarm system, or the like, to give a user an alert. In other embodiments, the alert device 700 may interface with a navigation system to give a user visual and/or audible alerts. In still further embodiments, an alert may be provided in the form of vibration or other types of tactile stimulus.

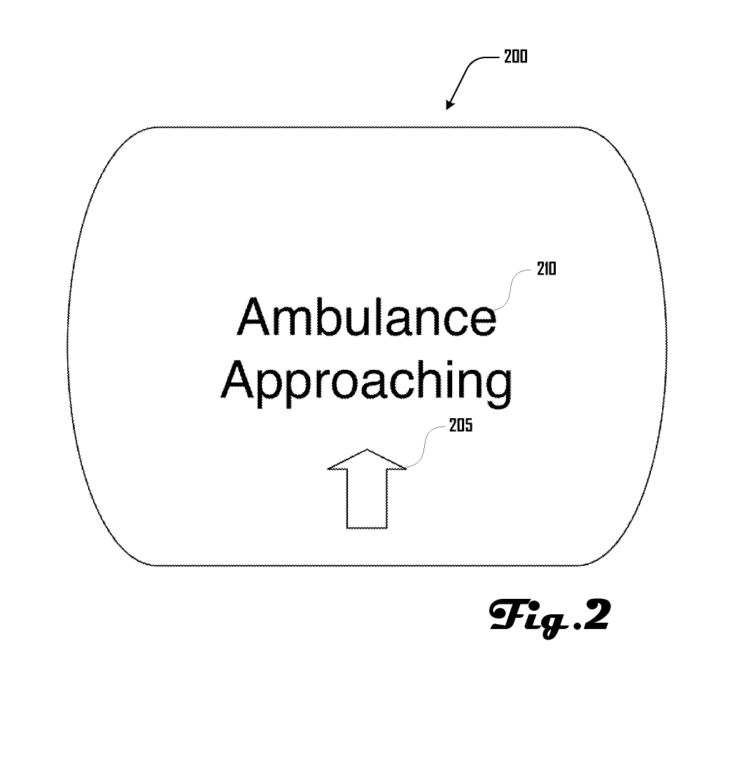

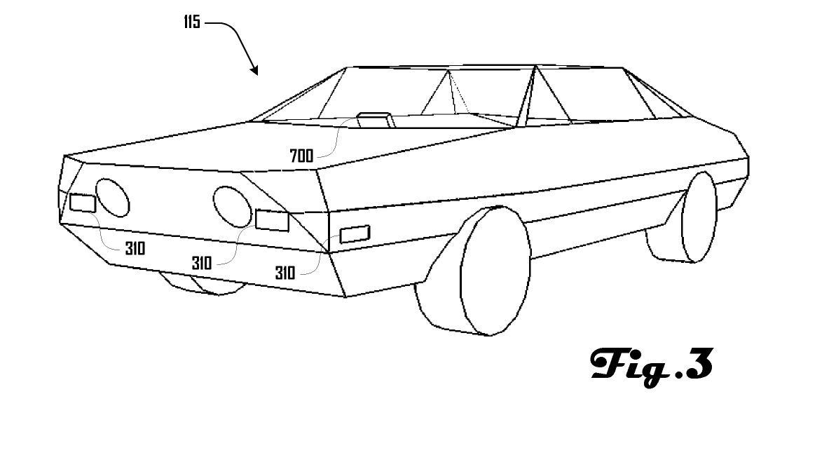

In still other embodiments, for example, as depicted in FIG. 3, the alert device 700 may activate one or more indicator 310 when the alert device 700 detects a nearby emergency vehicle 105. This may be desirable in various embodiments because a driver of the vehicle, drivers of other vehicles, pedestrians, and other persons, may thereby be alerted to an emergency event. In yet another embodiment, the alert device 700 may interface with a heads-up, dashboard-mounted, or other visual display to give a visual alert 200 to a user, as illustrated in FIG. 2.

In various embodiments, a user may receive a general alert regarding an emergency event, which may include a visual or audible alert, and the like. In other embodiments, a user may be presented with an alert that comprises directionality. For example, in some embodiments, a user may be presented an alert that comprises an arrow 205 pointing to the direction of an approaching emergency vehicle 105 (see, e.g. FIG. 2), an array of lights that indicates direction of an oncoming emergency vehicle 105, a text presentation of a direction (e.g. left, right, front, back, north, west, northwest, and the like), presentation of a time on a clock, and the like. One of ordinary skill in the art should appreciate the vast number of ways that a user may receive an alert that comprises information regarding directionality, and all such possibilities are within the scope and spirit of various embodiments.

For example, in FIG. 2, an alert device 700 is depicted presenting an alert 200 of an “approaching ambulance” 210, but also to the direction from which the emergency vehicle 105 is approaching via an arrow 205. In some embodiments, a user may also receive a further visual alert or audible alert. In further embodiments, a user may receive an alert 200 differentiating between various types of emergency events. For example, an alert device 700 may be operable to differentiate between, an ambulance, police vehicle, a military vehicle, a municipal vehicle, a fire department vehicle, and the like. In various other embodiments, an alert device 700 may be operable to differentiate between types of vehicles, such as a car, truck, bicycle, moped, Segway®, aircraft, train, light rail train, and the like. In still further embodiments, an alert device 700 may be operable to identify stationary events, stationary objects or stationary emergency events, including persons, an emergency beacon and the like.

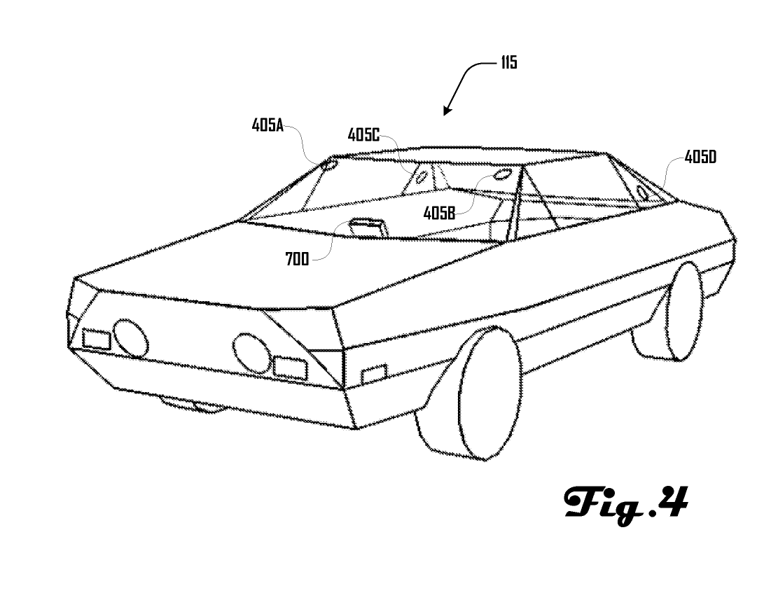

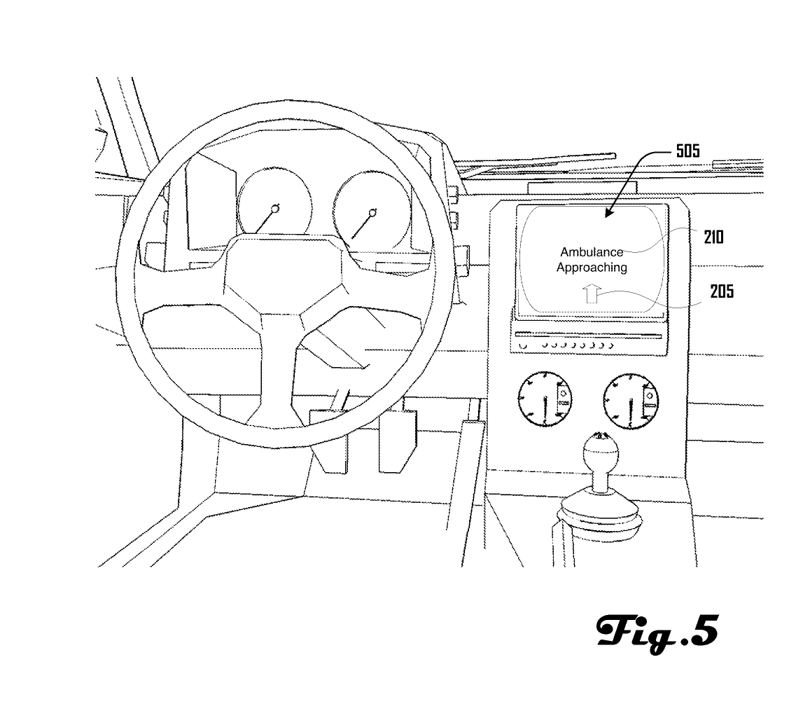

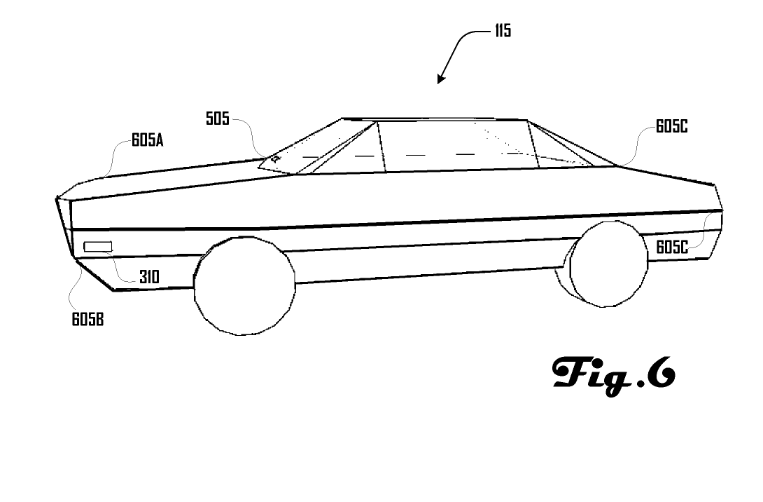

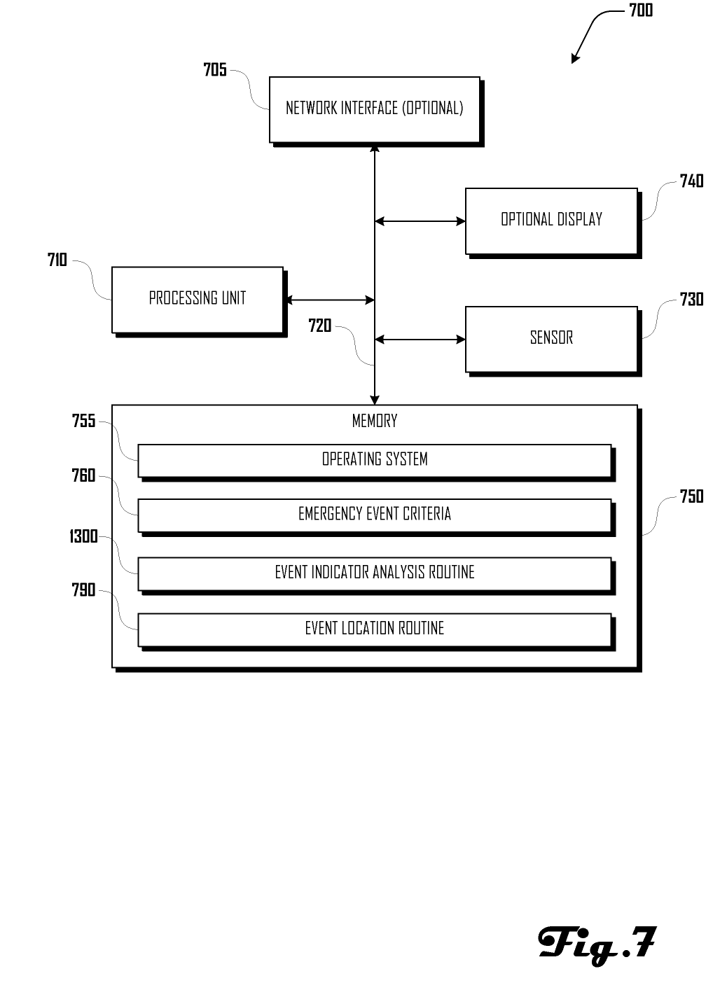

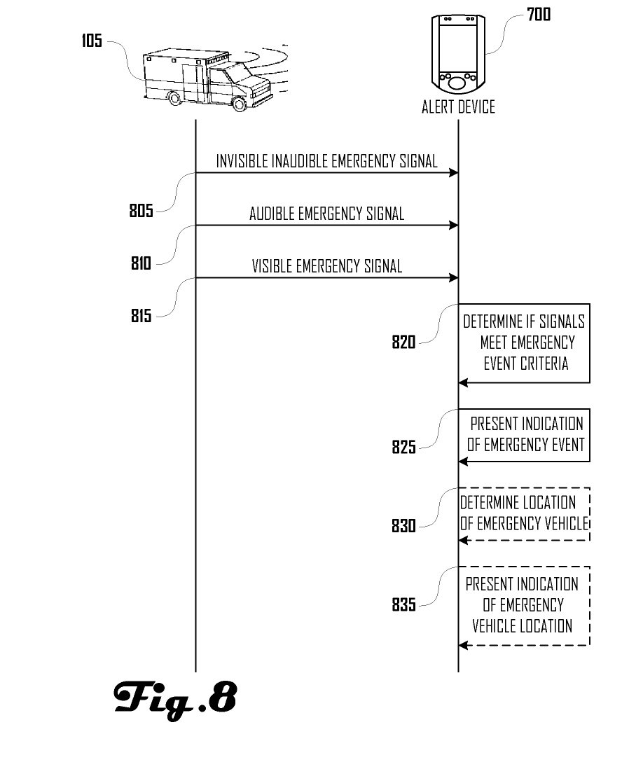

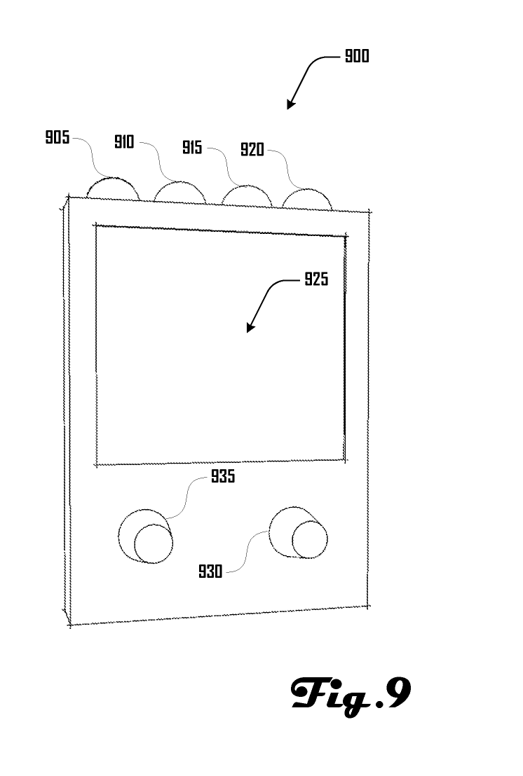

FIGS. 3-9 depict various embodiments that include at least three general configurations of an alert device 700: as a standalone unit (FIGS. 3 and 9), as a multi-component device (FIG. 4), and as a fully-integrated system (FIGS. 5 and 6). The following figures are presented for purposes of illustration only, and should not be construed to limit the scope and spirit of the many potential embodiments. FIG. 7 depicts an exemplary operating environment for an alert device 700. FIG. 8 depicts actions taken by an alert device 700 according to various embodiments. FIG. 9 depicts an exemplary embodiment of a stand-alone alert device 700.

FIG. 3, depicts a stand-alone alert device 700, which may comprise a single device that may be mounted in a car on a temporary, semi-permanent, or permanent basis. In various embodiments, a standalone alert device 700 may be advantageous from a cost perspective, or it may be advantageous for those who desire to easily transfer the device from vehicle 115 to vehicle 115, such as for a person who travels extensively and rents different vehicles 115. In some embodiments, a stand-alone device may integrate with various systems of a vehicle 115 such as an alarm system, computer system, audio system, air conditioning system, or the like.

FIG. 4 depicts a multi-component alert device 700, in accordance with one embodiment. The multi-component alert device 700 may comprise a plurality of sensors 405A-D that may be installed in or on a vehicle 115 in various locations. As illustrated in FIG. 4, one embodiment may have two sensors 405A, 405B coupled to the front windshield and two sensors 405C, 405D coupled to the rear windows. It should be clear to one of ordinary skill in the art that one or more sensors may be coupled to a vehicle 115 in various positions about the vehicle 115 and that such configurations are well within the scope and spirit of various embodiments. Having an array of sensors 405A-D may be desirable in some embodiments because such a configuration may allow the multi-component alert device 700 to detect and triangulate a greater range of signals, allowing the multi-component alert device 700 to provide more accurate directional feedback to a user than that provided by a standalone alert device 700.

In some embodiments, a multi-component alert device 700 may be integrated into one or more vehicle 115 system as described herein. In some embodiments, it may be less integrated, relying on an internal visual display or audible warning to alert a user. In other embodiments, it may be greatly integrated, utilizing many of the same feedback methods as a fully integrated system, as described below.

FIG. 5 depicts a visual display 505 for a fully-integrated alert device 700 that may be integrated with a vehicle's 115 instrumentation. For example, the display 505 may be a global positioning system, video system, or the like. In addition, a fully integrated alert device 700 may be integrated with a wide array of other systems that may be used to alert a user to the presence of a nearby emergency vehicle 105 or other emergency event. For example, the alert device 700 may be integrated with a vehicle 115 sound system such that it may override or interrupt a user's listening material to inform a user that an emergency vehicle 105 is approaching from a particular direction. In alternate embodiments, the alert device 700 may trigger a vehicle's 115 turn-indicators 310, hazard-indicators, brake indicators, flash interior lights, automatically brake the vehicle, utilize a built-in navigation system to alert a user, or the like.

In many embodiments, the alert device 700 may be upgradeable so that it may keep up with changing signals broadcast by emergency vehicles 105. In some embodiments, the alert device 700 may be able to identify the specific type of emergency vehicle 105, and alert a user as to which type of vehicle is approaching. This level of detail may be advantageous in various embodiments if the alert device 700 is used in an emergency vehicle 105. For example, a police officer may find it useful to be alerted to whether an approaching emergency vehicle 105 is another police car, a fire truck, or an ambulance. Accordingly, in various embodiments, an alert device 700 may be programmed or configured to selectively present an alert for only selected types of emergency events. For example, a user may configure an alert device 700 to only provide an alert if police or military vehicles are approaching. In another example, a user may configure an alert device 700 to provide an alert in response to only an emergency beacon.

FIG. 6 depicts a fully-integrated alert device 700, which may be a system that is installed or coupled to a vehicle in the factory, by a dealer or the like. As illustrated in FIG. 6, a full car integrated alert device 700 may position sensors 605A-D outside the cabin, far apart at the corners of the vehicle. In various embodiments, this may be desirable, because the sensors 605A-D may cover a wide range of wave bands, including sound waves, visible wave bands, and the like. Additionally, this may also be desirable in some embodiments because the sensors 605A-D are positioned as far apart as the physical confines of the vehicle will allow, and therefore may triangulate directional information with increased accuracy.

FIG. 7 illustrates several components of an exemplary alert device 700 for an embodiment. Those of ordinary skill in the art and others will appreciate that the alert device 700 may include many more components than those shown in FIG. 7. However, it is not necessary that all of these generally conventional components be shown in order to disclose an enabling embodiment for practicing the embodiments described herein.

As shown in FIG. 7, the alert device 700 includes an optional network interface 705 for connecting to remote devices (not shown). The optional network interface 705 may be a network interface designed to support a local area network (“LAN”), wireless local area network (“WLAN”), personal area network (“PAN”), Worldwide Interoperability for Microwave Access (“WiMax”), telephone network, pager network, powerline connection, serial bus, universal serial bus (“USB”) wireless connection, or the like. The optional network interface 705 includes the necessary circuitry, driver and/or transceiver for such a connection and is constructed for use with the appropriate protocols for such a connection. In various embodiments the network interface 705 may be absent.

As shown in FIG. 7, the alert device 700 includes a sensor 730 for detecting, obtaining or receiving a signal of various types. For example, the sensor 705 may be operable to detect waves of various wavelengths or frequencies, which may include radio waves, microwaves, light waves, light particles, sound waves, and the like. Additionally, an event source or emergency event source can be various types of vehicles, events, emergency events, devices, weather phenomena, geologic phenomena, or any source of one or more signal that can be obtained, received, or detected by an alert device.

The alert device 700 also includes a processing unit 710, an optional display 740 and a memory 750, all interconnected along with the network interface 730 via a bus 720. Those of ordinary skill in the art and others will appreciate that the display 740 may not be necessary in all embodiments and, accordingly, is an optional component. For example, an alert device 700 may use a display present in a vehicle or other location, or may provide an alert to a user via audio, or the like.

The memory 750 generally comprises random access memory (“RAM”), a read only memory (“ROM”) and a permanent mass storage device, such as a disk drive, flash RAM, or the like. The memory 750 stores the program code necessary for an event indicator analysis routine 1300 and an event location routine 790. Additionally, the memory 750 stores an operating system 755 and a database that comprises emergency event criteria 770.

It will be appreciated that the software components may be loaded from a computer readable medium into memory 750 of the alert device 700 using a drive mechanism (not shown) or network mechanism (not shown) associated with the computer readable medium, such as a floppy, tape, digital video disc (DVD)/CD-ROM drive, flash RAM, network interface card, or the like. In some embodiments, software components may be loaded or updated remotely via a network, which may be a wireless network.

In one exemplary embodiment, another alert device 700 or an alert server 1010 may configure or interact with an alert device 700 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (extensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to alert device 700 (e.g., displayed on the peer to peer display 1140) may be made familiar and user friendly.

Although an exemplary alert device 700 has been described that generally conforms to a conventional general-purpose computing device, those of ordinary skill in the art will appreciate that an alert device 700 may be any of a great number of devices capable of functioning as a device, server or operating environment that is within the spirit or scope of the embodiments described herein or may perform at least one function of the embodiments described herein.

FIG. 8 is a diagram illustrating the actions taken by an alert device 700 in accordance with various embodiments. The actions begin were an invisible inaudible emergency signal is obtained 805 by the alert device 700; an audible emergency signal is obtained 810 by the alert device 700; and a visible emergency signal is obtained 815 by the alert device 700. The emergency signals are sent, in this example, by an emergency vehicle 105.

In various embodiments, various types of emergency signals may be broadcast by an emergency vehicle 105 as described herein, which may include inaudible invisible emergency signals such as radio waves, micro waves, and other types of waves that cannot be perceived by an average human observer. Additionally, audible signals may be broadcast by an emergency vehicle 105, which may include a siren, alarm, or the like, which may be perceived by an average human observer. Additionally, visible signals may be broadcast by an emergency vehicle 105, which may include a light waves from a strobe light, light bar, rotating light, light emitting diode, xenon flash lamp, incandescent bulb, quartz halogen bulb, and the like, which may be observed by an average human observer.

In some embodiments, one or more type of signal may be broadcast by an emergency vehicle 105 or other source, and these three types of signals need not all be broadcast or obtained by an alert device 700 in all embodiments. In other embodiments, emergency signals may be broadcast from various other sources, for example, various vehicles, a fixed beacon, a portable beacon, a person, a building, a train crossing, a wireless network, an emergency broadcast signal, weather phenomena, a construction site, a road checkpoint, a toll station, a boarder checkpoint, a vehicle accident site, a public transportation vehicle, a global positioning device, a road sign, and the like.

In further embodiments, a signal can be received from a global positioning device, which may include data relating to the position, direction, and/or velocity of the device. Additionally, such a signal may include data regarding a vehicle, person, or event associated with the device. In various embodiments, such data can be used to determine the location of an event or emergency event and to present the presence, direction, and/or location of the event.

Returning to the actions, a determination 820 is made whether the obtained 805, 810, 815 signals meet emergency event criteria and an indication of an emergency event is presented 825. In optional steps, the location of the emergency vehicle 105 is determined 830 and an indication of the emergency vehicle 105 location is presented 835.

Regarding emergency event criteria, various criteria may be defined for a given event or given emergency event. For example, criteria for an emergency event associated with an approaching ambulance may be the presence of an invisible inaudible signal wave of frequency within a defined range and the presence of an audible signal within another defined range. This may correspond to a radio frequency broadcast by an ambulance and the pitch of the siren of an ambulance or other emergency vehicle.

In another example, another emergency criteria may be the presence of invisible inaudible signal wave of frequency within a defined range and the presence of a visible signal received at a defined frequency, which may correspond to a microwave emitted by an ambulance and the rate at which an ambulance strobe flashes.

In various embodiments one or more signal, wave, particle, or other indicator may be used to define an emergency event. In some embodiments, it may be desirable to use a plurality of signals to define an emergency event because false positives may occur if such signals are broadcast from other sources. However, it may be less likely that two or more signals will be present at a given time unless such signals correspond to the presence of the defined emergency event.

As used herein, the term “event” or “emergency event” may be used interchangeably, and need not necessarily refer to a situation of great emergency. For example an event or emergency event may be defined as the approach of an emergency vehicle 105 such as a fire truck, but an emergency event or event may also be defined as the approach of a train, the presence of an active railroad crossing gate, the presence of construction, the presence of a road obstruction, or the like. Accordingly, it should be clear to one of ordinary skill in the art that in various embodiments an alert device 700 may provide an alert for various events or situations, which may or may not be of an emergency nature.

FIG. 9 illustrates one possible embodiment of a portable standalone alert device 700 comprising various sensors 905, 910, 915, 920, a display 925, and controls 930, 935. Sensors may include a microphone 905, an RF sensor 910, an Infrared sensor 915, a visible light flash sensor 920, and/or other sensors as required. The portable standalone alert device 700 may be suitable for use by a pedestrian, a user in or about a vehicle, a user in various other locations, and the like. Controls may include, among others, an on/off/volume knob 935 and a sensitivity knob 930. In further embodiments, the portable standalone alert device 700 may be integrated into various portable devices such as a cellular telephone, global positioning device, gaming device, personal data assistant, portable computer, audio device, portable audio device, and the like.

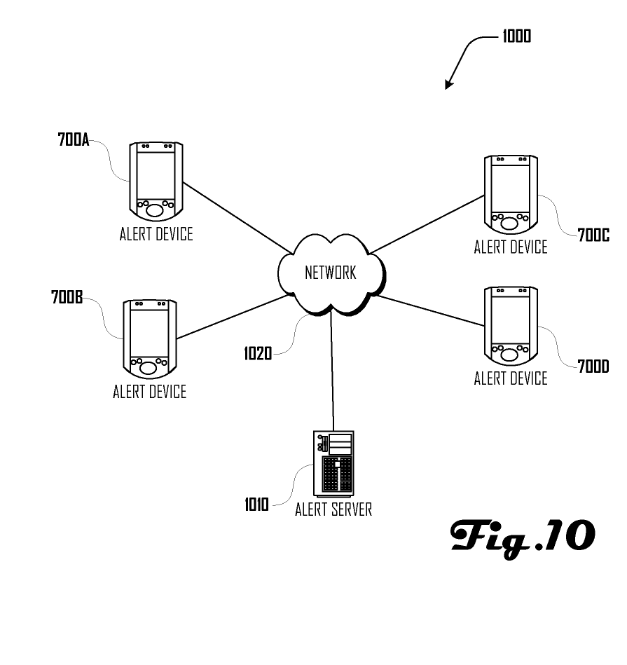

FIG. 10 is a pictorial diagram of a system 1000 of interconnected devices, in accordance with various embodiments. The system 1000 comprises a plurality of alert devices 700A-D and an alert server 1010, which are each operably connected via a network 1020. In various embodiments, the alert server 1010 may facilitate communication between one or more alert device 700A-D. For example, a first alert device 700A may encounter an emergency event, and may communicate the presence of the emergency event to the alert server 1010 and the emergency alert server 1010 may communicate the presence of the emergency event to one or more of the plurality of other alert devices 700B-D. However, in other embodiments, a first alert device 700A may communicate with another alert device 700B-D without facilitation by an alert server 1010. In other embodiments, an alert device 700A-D may be updated, configured, modified, or the like, by the alert server 1010. In yet another embodiment, communication between alert devices 700B-D may be achieved via a network that comprises a plurality of infrastructure nodes.

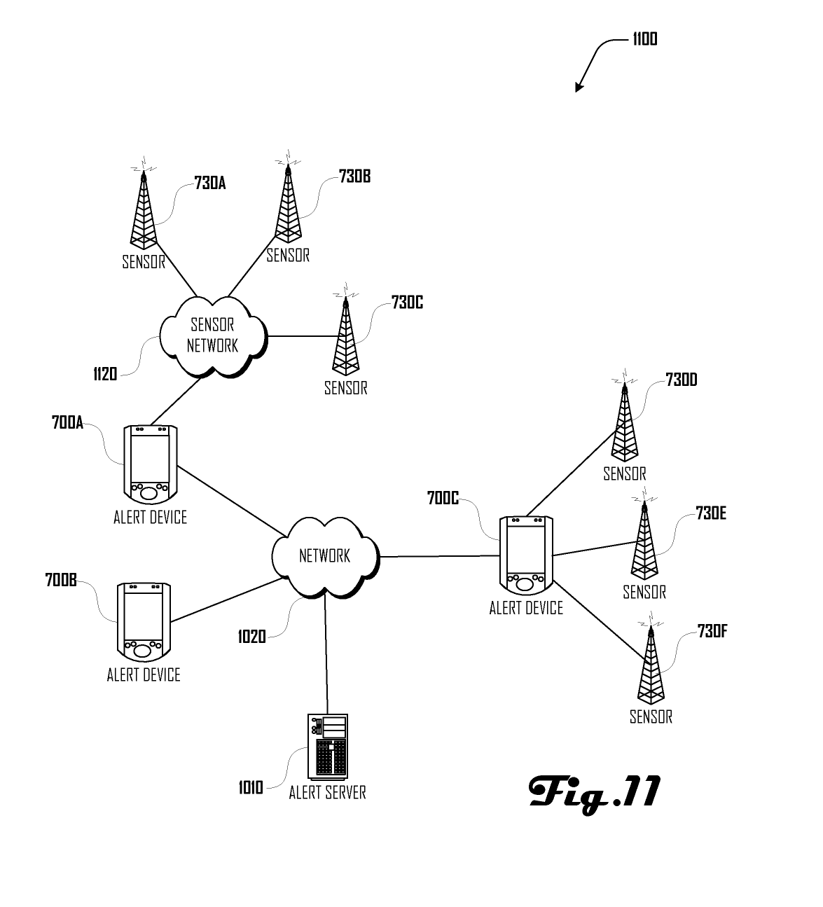

FIG. 11 is a pictorial diagram of a system 1100 of interconnected devices, in accordance with another embodiment. The system 1100 comprises a first, second and third alert device 700A-C and an alert server 1010, which are each operably connected via a network 1020. Additionally, the first alert device 700A is operably connected to a plurality of sensors 730A-C via a sensor network 1120. Additionally, the third alert device 700C is also operably connected to a plurality of sensors 730D-F. As depicted in FIG. 11, an alert device 700 may be connected to a plurality of sensors 110 either directly or via a sensor network 1120. Additionally, an alert device may comprise a plurality of sensors 730.

In one embodiment, various components of an alert device 700 may be located in disparate locations. For example, a plurality of sensors 1145 may be located in various locations around a street, such as on buildings, telephone poles, or the like. A signal may be detected by one or more disparately located sensor 1145 and data may be communicated to other disparately located components of the alert device 700, to another alert device 700, or the like. Accordingly, a network comprising a plurality of alert devices 700 may comprise alert devices 700 that are portable, coupled to a vehicle, permanently coupled to a vehicle, installed as an infrastructure array, and the like. In various embodiments, one or more alert device 700 may work cooperatively to determine whether an emergency event is present or determine the direction and/or location of an emergency event. In some embodiments, an alert device 700 may comprise one or more sensor 730, may be directly connected to one or more sensor 730, or may be connected to one or more sensor via a network.

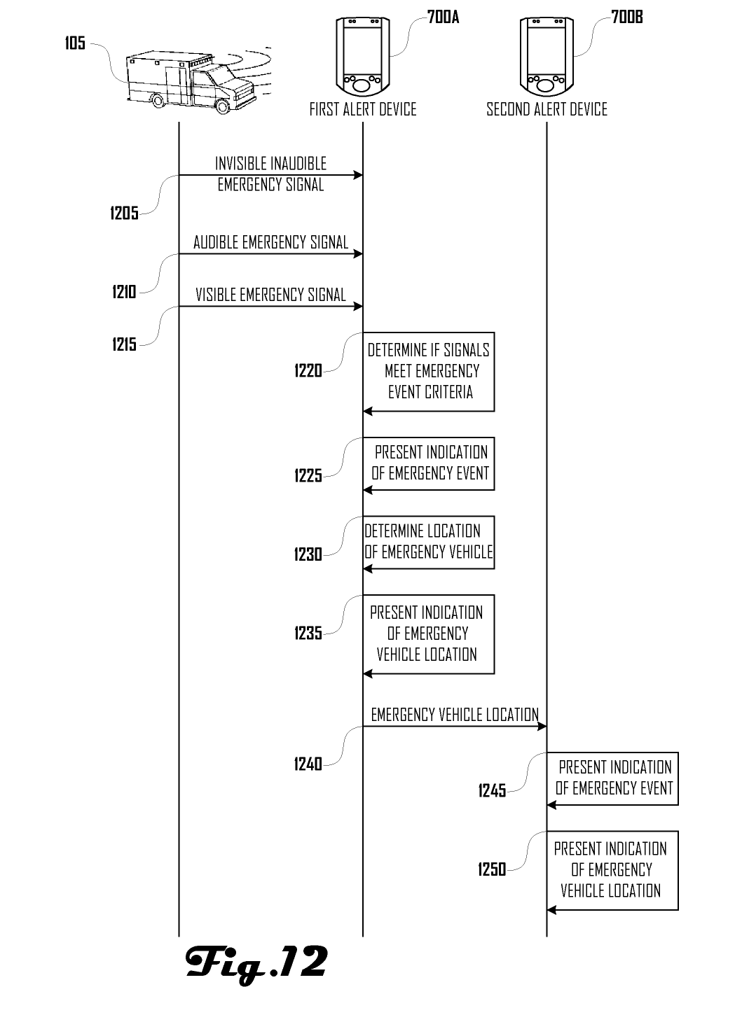

FIG. 12 is a diagram illustrating the actions taken by a pair of alert devices 700A, 700B in accordance with various embodiments. The actions begin where an invisible inaudible emergency signal is obtained 1205 by the first alert device 700A; an audible emergency signal is obtained 1210 by the first alert device 700A; and a visible emergency signal is obtained 1215 by the first alert device 700A. The emergency signals are sent, in this example, by an emergency vehicle 105.

As described herein, such signals or indicators may be sent, broadcast or obtained from various sources, and each type of signal need not be present. Returning to the actions, a determination 1220 is made whether the obtained 1205, 1210, 1215 signals meet emergency event criteria and, if so, an indication of an emergency event is presented 1225. The location of an emergency vehicle 105 is determined 1230 and an indication of the emergency vehicle 105 location is presented 1235 on the first alert device 700A.

The first alert device 700A may then send 1240 the emergency vehicle 105 location to the second alert device 700B and the second alert device 700B may present 1245 an indication of an emergency event and may present 1250 an indication of an emergency vehicle 105 location. In another embodiment, the first alert device 700A may send 1240 the location of an emergency event to an alert server 1010 and the alert server 1010 may send the location of the emergency event to the second alert device 700B. In a further embodiment, a plurality of alert devices 700 may obtain the location of an emergency event determined by another alert device 700.

In various embodiments the location of an emergency event, emergency event, event, or transmission place of emergency signals may be determined by triangulation and other methods known in the art. In some embodiments, global positioning system (“GPS”) coordinates, address, latitude and longitude, and the like, may be determined and sent to a plurality of alert devices 700. In further embodiments, velocity of an emergency vehicle 105 or other transmitter of an emergency signal may be determined, and the determined velocity may be sent to a plurality of alert devices 700.

In still further embodiments, an alert device 700 receiving the location or location and velocity of an emergency event may determine whether to present an alert of the emergency situation. For example, if the alert device 700 determines that the alert device 700 is not within proximity of the emergency event, or will not be within proximity of the emergency event, the alert device 700 may not display an alert relating to the emergency event. Additionally, if the alert device 700 determines that the alert device 700 is moving away from the emergency event or that the emergency event is moving away from the alert device 700, the alert device 700 may not display an alert relating to the emergency event.

In other embodiments, an alert device 700 may obtain and present alerts relating to various emergency events or other events. For example, from the emergency broadcasting system, an Amber alert, a weather report, traffic conditions, status of traffic lights, and the like. In various embodiments, an alert device 700 may display one or more alert on a map and may display the position of the alert device 700 on a map. In one embodiment, a user may define and/or input an emergency event that may be communicated among a plurality of alert devices 700. Such an event may be input or defined by a user configuring an alert device 700.

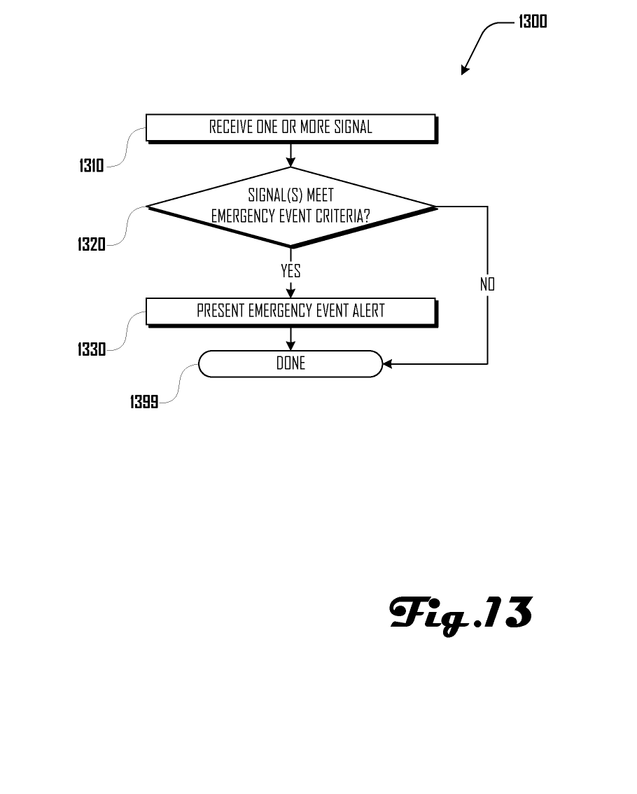

FIG. 13 is a block diagram of an event indicator analysis routine 1300 in accordance with an embodiment. The event indicator analysis routine 1300 begins in block 1310 wherein one or more signal or indicator is obtained. In block 1320 a determination is made whether the one or more signal or indicator meets a defined set of emergency event criteria. If so, an emergency event alert is presented in block 1330, and the routine is done 1399. However if the one or more signal does not meet the defined set of emergency event criteria, then the event indicator analysis routine 1300 is done.

In various embodiments, emergency event criteria may include the presence of various wave phenomena that correspond to sounds, light, radio waves, micro waves, and the like. Additionally, emergency event criteria may also include criteria such as location of an emergency event, frequency of the presence of a signal, presence of various signals together, velocity of a signal, and the like. For example, there may be a location that broadcasts signals that may be similar to an emergency event or an emergency signal, and emergency criteria may be such that signals received when in proximity to the location are scrutinized in light of the increased probability of a false positive.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes may be made without departing from the spirit and scope of the embodiments described herein.

1. A method of providing an emergency event alert, the method comprising:
obtaining criteria for detecting an emergency event,
detecting at least one event indicator from an emergency event source,
determining whether said at least one event indicator meets said criteria for said emergency event; and
presenting an alert of the presence of said emergency event.

2. The method of claim 1, wherein
said criteria for an emergency event comprises presence of an invisible inaudible emergency signal; and
said at least one event indicator comprises an invisible inaudible signal.

3. The method of claim 2, wherein said inaudible invisible emergency signal is an emergency vehicle preemption signal.

4. The method of claim 1, wherein
said criteria for an emergency event comprises presence of a visible emergency signal; and
said at least one event indicator comprises a visible signal.

5. The method of claim 2, wherein said visible emergency signal is an emergency light.

6. The method of claim 1, wherein
said criteria for an emergency event comprises presence of an audible emergency signal; and
said at least one event indicator comprises an audible signal.

7. The method of claim 1, further comprising:
determining the approximate direction of the source of said event indicator; and
wherein said presenting comprises indicating an approximate direction of said source of said event indicator.

8. An emergency event alert apparatus comprising:
a memory for storing obtained criteria for an emergency event;
a sensor for obtaining at least one event indicator from an emergency event source;
a processor for determining whether said at least one event indicator meets said criteria for said emergency event; and
a display for presenting an alert of the presence of said emergency event, and
wherein said criteria for an emergency event further comprises at least one of:
presence of an inadudible invisible emergency signal;
presence of an audible emergency signal, and
presence of a visible emergency signal; and
wherein said at least one event indicator further comprises at least one of:
an inadudible invisible emergency signal
an audible signal, and
a visible signal.

9. The apparatus of claim 8 wherein said processor is further operable for determining an approximate direction of said emergency vehicle and said display is further operable to indicate the approximate direction of said emergency vehicle in relation to the apparatus.

10. The apparatus of claim 8 wherein said processor is further operable for determining an approximate location of said emergency vehicle and said display is further operable to indicate the approximate location of said emergency vehicle in relation to the apparatus.

11. The apparatus of claim 8,
wherein said criteria for an emergency event comprises presence of an inadudible invisible emergency signal;
wherein said at least one event indicator comprises an inaudible invisible emergency signal; and
wherein said inaudible invisible emergency signal is an emergency vehicle preemption signal.

12. The apparatus of claim 8,
wherein said criteria for an emergency event comprises presence of an audible emergency signal;
wherein said at least one event indicator comprises an audible emergency signal; and
wherein said audible emergency signal comprises an emergency vehicle siren.

13. The apparatus of claim 8,
wherein said criteria for an emergency event comprises presence of a visible emergency signal;
wherein said at least one event indicator comprises a visible emergency signal; and
wherein said visible emergency signal comprises an emergency vehicle light.

14. An emergency event alert system comprising:
a first and second emergency alert device, each comprising:
a memory for storing obtained criteria for an emergency event;
a sensor for obtaining at least one event indicator from an emergency vehicle;
a processor for
determining whether said at least one event indicator meets said criteria for said emergency event, and
determining a location of said emergency vehicle; and
a display for presenting
an alert of the presence of said emergency event, and
an indication of an approximate location of said emergency event, and
wherein said first emergency alert device is operable to detect the presence of an emergency event source and determine an approximate location of said emergency event source and communicate said approximate location of said emergency event source to said second emergency alert device.

15. The system of claim 14 wherein
said criteria for an emergency event further comprises at least one of:
presence of an inadudible invisible emergency signal;
presence of an audible emergency signal, and
presence of a visible emergency signal; and
said at least one event indicator further comprises at least one of:
an inadudible invisible emergency signal
an audible signal, and
a visible signal.

16. The system of claim 14, wherein said inaudible invisible emergency signal is an emergency vehicle preemption signal.

17. The apparatus of claim 14, wherein said at least one event indicator comprises an audible emergency signal, and
wherein said audible emergency signal comprises an emergency vehicle siren.

18. The apparatus of claim 14, wherein said at least one event indicator comprises a visible emergency signal, and
wherein said visible emergency signal comprises an emergency vehicle light.

19. The system of claim 14, wherein said second emergency alert device is operable to detect the presence of an emergency vehicle and determine an approximate location of said emergency vehicle and communicate said approximate location of said emergency vehicle to said first emergency alert device.

20. The system of claim 19 wherein said communication is facilitated by an alert server.
